(19) United States
(12) Patent Application Publication
(10) Pub. No.: US 2018/0260928 A1
(43) Pub. Date: Sep. 13, 2018

(54) SYSTEMS, METHODS AND COMPUTER PROGRAM PRODUCTS FOR AGGREGATION, ANALYSIS, AND VISUALIZATION OF LEGISLATIVE EVENTS

(71) Applicant: Athlon Communications, Inc., New York, NY (US)

(72) Inventor: BRADLEY W. BLOCH, New York, NY (US)

(73) Assignee: Athlon Communications, Inc., New York, NY (US)

(21) Appl. No.: 15/918,523

(22) Filed: Mar. 12, 2018

Related U.S. Application Data
(60) Provisional application No. 62/469,928, filed on Mar. 10, 2017.

(51) Int. Cl. G06Q 50/26; G06F 17/30

(52) U.S. Cl. CPC G06Q 50/26; G06F 17/30554; G06F 17/30424; G06F 17/30371; G06F 17/30339; G06F 17/30303

(57) ABSTRACT

Methods, systems and computer programs products are provided, for aggregating, analyzing and visualizing legislative events, including voting patterns, political action committee (PAC) and candidate committee activity patterns, interactions between legislators and involvement by legislators in news events.

### FIELD OF THE INVENTION

The present invention relates to methods, system and computer program products for aggregating, analyzing and visualizing legislative events, including voting patterns, political action committee (PAC) and candidate committee activity patterns, interactions between legislators and involvement by legislators in news events.

### BACKGROUND OF THE INVENTION

In contemporary democratic political systems, the action of legislative bodies has significant economic impact due to their authority to direct government expenditures (appropriations), regulation and policy. As a result, significant effort by parties outside of government is expended attempting to track and analyze legislative events. The factors that are subject to analysis may include, but are not limited to: a) the various voting coalitions that may be present in a given legislative body, b) movement by members among coalitions, c) the relationships between members that may come from co-sponsorship of bills or contributing to each other's campaign committees, d) the relationships between members that may come from shared involvement in unfolding news events or shared positions taken on proposed legislation, e) the relationships between members that may come from receiving contributions from the same Political Action Committees (PACs), f) the relationships between PACs that may come from contributing to the same members, and g) identification of floor votes that are treated in a similar fashion by the legislative body.

Because there is no standard platform by which legislative events can be quantitatively analyzed, virtually all such analysis is highly qualitative in nature. All qualitative analysis is vulnerable to a wide range of biases; this vulnerability is heightened in political analysis because political analysis is often undertaken in the hope of affecting some outcome, which can naturally hinder the ability to analyze objectively. In particular, the principal players themselves (legislators and PACs) cannot, given the nature of political discourse, be expected to objectively describe and categorize their own behavior. In addition, the number of variables involved (legislative members, PACs, votes, etc.) makes it difficult for patterns to be uncovered using currently applied analytical techniques.

One measure of the effort devoted to analyzing legislative events can be found in the annual expenditures in Congressional lobbying in the United States, which was estimated by the Sunlight Foundation® to be $6.7 billion in 2012. In recent years, advances in both data analysis and data visualization have allowed a wider range of data sets to be analyzed quantitatively, allowing for patterns in events to be identified. While advances have been made in applying data analysis to legislative events, such applications display one or more shortcomings: a) they may represent one chamber at one moment in time, making it impossible to identify trends over time, b) they may involve visualizations that are difficult for the user to interpret, or which cannot be used as the basis for concrete understanding or strategic action, c) they may lack important ancillary analytical data that provide context for interpretation, and/or d) they may lack the ability for the user to control important variables in the analysis and visualization.

There is an unmet need in the art for systems, methods and computer program products that overcome the above issues and provide an objective platform for analysis of legislative events.

### BRIEF SUMMARY OF THE INVENTION

The present disclosure provides various methods and systems for generating a visualization of legislative events which reduce or eliminate the above-identified problems in the art. In addition, selected aspects of the disclosure provide other benefits and solutions as discussed in detail below.

In a first exemplary aspect, a computer-implemented method for generating a visualization of legislative events according to the present disclosure comprises: receiving, by a database on a server, at least one data set from one or more data repositories, the data set comprising one or more of legislative member attributes, legislative member votes, vote attributes, political action committee affiliations, political action and campaign committee contributions, and political action and campaign committee attributes, associated with at least one political entity, in at least one data format selected from the group consisting of XML, YAML, CSV and data extracted from an HTML page; generating a scrubbed data set suitable for querying, by scrubbing at least one received data set to create a unique list of candidate committees associated with at least one current or former legislative member, wherein a data table that links current or former legislative members with candidate committees is cross-referenced against a manually maintained table to resolve incomplete and inconsistent data in the received data sets; receiving, by the database, vote data comprising information about at least one voting event conducted by a legislative body, wherein the vote data is received by the database from one or more data repositories as a plurality of tables and is combined via a program running on the server into a single table within the database; analyzing the scrubbed data set and/or vote data, by the server, based upon a query from a user comprising one or more parameters stored in the database; and displaying the result of the query on a user interface.

In select aspects, the method further comprises storing the scrubbed data set in a non-transitory computer readable storage medium using an open-source relational database management system based on structured query language (SQL) by: downloading, loading, aggregating, and analyzing the scrubbed data set periodically using BASH, PHP and R scripts executed by the server's processor; aggregating the scrubbed data set; and storing the aggregated data in aggregated tables configured to simplify and/or speed up processing of the stored data.

In select aspects, analyzing the scrubbed data set comprises: receiving or identifying a date range parameter comprising a datetime (t₀) and a datetime (tₙ), based on the user query; dividing the date range into n sections (t₀, tₙ); and generating a series of data sets at each point tₓ where 1≤x≤n.

In select aspects, analyzing the scrubbed data set comprises: analyzing the scrubbed data set in a chronological sequence, based on the user query; and determining one or more patterns as a function of time; wherein the resulting patterns are displayed on the user interface as the result of the user query.

In select aspects, the scrubbing of the received data set is performed by the execution of a program scheduled to execute daily on the server.

In select aspects, analyzing the scrubbed data set comprises processing at least a subset of the data in the scrubbed data set using a divisive or agglomerative hierarchical clustering procedure.

In select aspects, analyzing the scrubbed data set comprises: processing at least a subset of the data in the scrubbed data set using a divisive or agglomerative hierarchical clustering procedure to generate one or more clusters of data, wherein the one or more clusters of data are grouped using a predetermined dissimilarity criteria.

In select aspects, the at least one political entity comprises: a) a United States Congress; b) a United States state legislature; or c) a legislative body of a national, regional or municipal jurisdiction of any country, political union or territory. Exemplary legislative bodies include the European Parliament of the European Union, and any national, regional or municipal congress of a foreign country (regardless of whether such legislative body has a direct U.S. analog). Legislative bodies may comprise representatives that are elected or appointed. A legislative body may also comprise a subset of a larger legislative body that is organized as a distinct group (e.g., the U.S. Senate or a house of the British Parliament).

In select aspects, the data set received by the server further comprises at least one of biographic, political action committee affiliation, or bill sponsorship information associated with one or more members of the at least one political entity.

In select aspects, the vote data received by the database comprises information regarding at least one bill, public or private law, resolution, or treaty voted on by one or more members of the at least one political entity.

In select aspects, the data set received by the database comprises information about at least one political action committee and its contribution to a candidate committee of a current or former member of the at least one political entity.

In select aspects, the open-source data table that links current or former members with candidate committees is a publicly-accessible resource hosted on a remote server.

In select aspects, the method further comprises a step of defining, by the user, custom attribute data to be included in the at least one data set received from the one or more data repositories.

In another exemplary aspect, the disclosure provides a computer-implemented method for generating a visualization of legislative events, comprising: a database on a server; and a processor configured to: receive, by the database, at least one data set from one or more data repositories, the data set comprising one or more of legislative member attributes, legislative member votes, vote attributes, political action committee affiliations, political action and campaign committee contributions, and political action and campaign committee attributes, associated with at least one political entity, in at least one data format selected from the group consisting of XML, YAML, CSV and data extracted from an HTML page; generate a scrubbed data set suitable for querying, by scrubbing at least one received data set to create a unique list of candidate committees associated with at least one current or former legislative member, wherein a data table that links current or former legislative members with candidate committees is cross-referenced against a manually maintained table to resolve incomplete and inconsistent data in the received data sets; receive, by the database, vote data comprising information about at least one voting event conducted by a legislative body, wherein the vote data is received by the database from one or more data repositories as a plurality of tables and is combined via a program running on the server into a single table within the database; analyze the scrubbed data set and/or vote data, by the server, based upon a query from a user comprising one or more parameters stored in the database; and display the result of the query on a user interface.

In select aspects, a system is provided wherein the processor is configured to perform any of the steps required by the methods disclosed here, alone or in combination.

In another exemplary aspect, a computer-readable storage medium is provided containing instructions that when executed direct a processor to perform any of the steps required by the methods disclosed here, alone or in combination.

Additional advantages and novel features in accordance with aspects of the invention will be set forth in part in the description that follows, and in part will become more apparent to those skilled in the art upon examination of the following or upon learning by practice thereof.

### BRIEF DESCRIPTION OF THE DRAWINGS

FIG. 1 is a schematic diagram of a system in accordance with various example aspects of the invention.

FIG. 2 is a process flow diagram of a data loading and scrubbing process in accordance with various example aspects the invention.

FIG. 3 is a diagram showing continuous and discrete modes in accordance with various example aspects of the invention.

FIG. 4 is a dendrogram showing cluster analysis in accordance with various example aspects of the invention.

FIG. 5 is a time/cluster cut-height data array for visualization in accordance with various example aspects of the invention.

FIG. 6 is a screenshot of a tree-view visualization of clustering of legislative members into clusters and sub-clusters, based on voting history, in accordance with various example aspects of the invention.

FIG. 7 is a screenshot of a node-link visualization that represents relationships between legislators with links between nodes in accordance with various example aspects of the invention.

FIG. 8 is a screenshot of a node-link visualization showing clusters of legislative members at various points in time arranged in columns, and movement between clusters represented as edges in accordance with various example aspects of the invention.

FIG. 9 is a screenshot showing analysis for accompanying clustering of legislative members by voting history, allowing for identification of differences in clusters in accordance with various example aspects of the invention.

FIG. 10 is a screenshot showing analysis for accompany clustering of votes, allowing for identification of differences in how clusters of votes were received by members in accordance with various example aspects of the invention.

FIG. 11 is a screenshot showing the analysis for accompanying clustering of political action committees for identification of similar committees in accordance with various example aspects of the invention.

FIG. 12 is a screenshot showing analysis for accompanying the clustering of legislative members by contributions received from political action committees for identification of differences in clusters in accordance with various example aspects of the invention.

FIG. 13 is a screenshot showing the highlighting of legislative members' names by an annotation browser extension in accordance with various example aspects of the invention.

FIG. 14 is a screenshot showing creation of a news attribute and its assignment to a legislative member in accordance with various example aspects of the invention.

FIG. 15 is a diagram of an exemplary system architecture compatible with the disclosed methods.

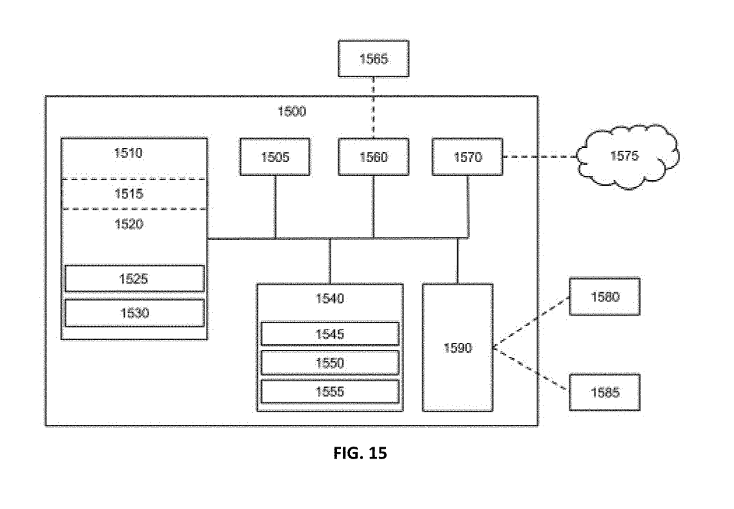

FIG. 16 is a diagram of the overall workflow of the invention.

These and other features and advantages in accordance with aspects of this invention are described in, or are apparent from, the following detailed description of various example aspects.

### DETAILED DESCRIPTION

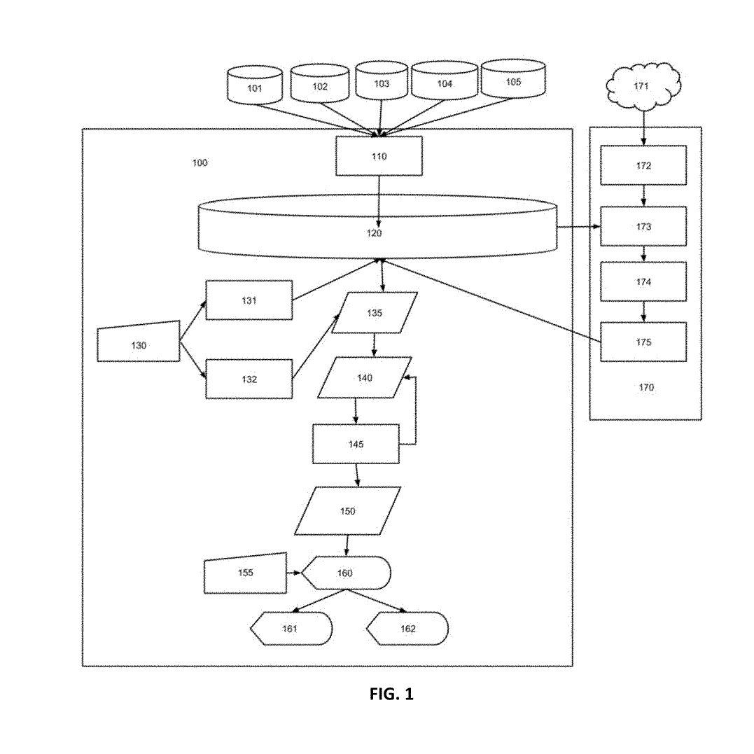

Aspects of the present invention are directed to systems, methods and computer program products having various modules and processes for aggregation, analysis and visualization of legislative events. FIG. 1 shows a schematic diagram of a system 100 in accordance with various example aspects of the invention. The system 100, for example, an analytic platform, may be used to aggregate, analyze and visualize a wide range of data relating to legislative events. The data may be, for example, open-source data or proprietary data collected by running automated scripts daily to download data from the third parties in multiple formats (XML, CSV, JSON and YAML). This data is then extracted and transformed into the structure set forth in the systems database table layout given in Table 1. The transformed data is then loaded into the database. The data provided may be in extensible markup language (“XML”) format, human-readable data serialization format (e.g., YAML), comma separated values (“CSV”) format or data extracted from hypertext markup language (“HTML”) pages using standard web scraping methods such as using software written to download web pages from an internet site (in this instance www.house.gov and www.senate.gov), analyze the information in the webpage to extract data that meets pre-defined criteria and return an XML document containing that data. For example, a script could be written to extract legislator names or bill numbers, dates of introduction and vote tallies.

The data may include, for example, member attribute data 101, member votes data 102, vote attributes data 103, committee contributions data 104 and committee attributes data 105. The member attribute data 101 can include, for example, name, political party, term of service, state and district, legislative committee memberships, likelihood of reelection and other attributes. The member votes data 102 may include, for example, records of all votes taken within a legislature. The vote attributes data 103 can include, for example, attributes of each vote taken including sponsor and cosponsors, vote count, passage status, related amendments and other vote attributes. The committee contributions data 104 may include, for example, a list of contributions from political action committees (PACs) to candidate campaign committees, from PACs to PACs and from candidate committees to candidate committees. The committee attributes data 105 can include, for example, a list of committee attributes, including committee name and parent organization. Table 1 shows example data inputs representing data 101, 102, 103, 104, 105 in accordance with various example aspects of the invention.

TABLE 1
Exemplary Data Inputs

| | | | Full name | |
|---|---|---|---|---|
| | | | (when | |
| System | | | different from | |
| name | Source | Source name | source name) | Description |
| fec_ccl | FEC | ccl14.zip** | Candidate to | Links candidates to |
| | | | Committee | committees registered |
| | | | Linkage File | with the Federal Election |
| | | | | Commission (″FEC″) |
| fec_cm | FEC | cm14.zip** | Committee Master | Contains a record for each |
| | | | File | committee registered with |
| | | | | the FEC, including federal |
| | | | | PACs and party |
| | | | | committees, campaign |
| | | | | committees for presidential |
| | | | | and congressional offices, |
| | | | | and organizations spending |
| | | | | money for against federal |
| | | | | candidates |
| fec_pas2 | FEC | pas214.zip** | Contributions to | Contains each contribution |
| | | | Candidate from | or independent expenditure |
| | | | Committees | made by a PAC, party |
| | | | | committee, candidate |
| | | | | committee, or other federal |
| | | | | committee to a candidate |
| | | | | during the two-year election |
| | | | | cycle. |
| fec_cn | FEC | cn14.zip** | Candidate | One record for each |
| | | | Master File | candidate who has filed |
| | | | | FEC Form 2 for the |
| | | | | upcoming election, as well |
| | | | | as candidates with active |
| | | | | campaign committees or |
| | | | | who are referenced as part |
| | | | | of a draft or non-connected |
| | | | | committee supporting or |
| | | | | opposing a particular |
| | | | | candidate |
| github_ | Sunlight | legislators-current.yaml, | | FEC ID's for the members |
| legislators_ | Foundation | legislators-historical.yaml | | of the United States |
| fec | | | | Congress, current and |
| | | | | historical. |
| github_ | Sunlight | legislators-current.yaml, | | Term dates for the |
| legislators_ | Foundation | legislators-historical.yaml | | members of the United |
| terms | | | | States Congress, current |
| | | | | and historical. |
| github_ | Sunlight | legislators-current.yaml, | | Members of the United |
| legislators | Foundation | legislators-historical.yaml | | States Congress, 1789- |
| | | | | Present, in YAML, as well |
| | | | | as committees, presidents, |
| | | | | and vice presidents. |
| github_ | Sunlight | THOMAS | | Data collected from |
| bills (*) | Foundation | (Library of Congress) | | THOMAS an official |
| | | website via bills.pyc script | | governmental source for |
| | | provided by the Sunlight | | legislative information, run |
| | | Foundation | | by the Library of Congress, |
| | | | | which covers 1973 (93rd |
| | | | | Congress) to the present. |
| github_bills_ | Sunlight | THOMAS | | Data collected from |
| sponsors | Foundation | (Library of Congress) | | THOMAS, an official |
| | | website via bills.pyc script | | governmental source for |
| | | provided by the Sunlight | | legislative information, run |
| | | Foundation | | by the Library of Congress, |
| | | | | which covers 1973 (93rd |
| | | | | Congress) to the present. |
| github_bills_ | Sunlight | THOMAS | | Data collected from |
| cosponsors | Foundation | (Library of Congress) | | THOMAS, an official |
| | | website via bills.pyc script | | governmental source for |
| | | provided by the Sunlight | | legislative information, run |
| | | Foundation | | by the Library of Congress, |
| | | | | which covers 1973 (93rd |
| | | | | Congress) to the present. |
| github_bills_ | Sunlight | THOMAS | | Data collected from |
| subjects | Foundation | (Library of Congress) | | THOMAS, an official |
| | | website via bills.pyc script | | governmental source for |
| | | provided by the Sunlight | | legislative information, run |
| | | Foundation | | by the Library of Congress, |
| | | | | which covers 1973 (93rd |
| | | | | Congress) to the present. |
| github_ | Sunlight | committees-current.yaml, | | All current (historical) |
| committees | Foundation | committees-historical.yaml | | House, Senate, and Joint |
| (*) | | | | committees of the United |
| | | | | States Congress, based on |
| | | | | data scraped from the U.S. |
| | | | | House and Senate |
| | | | | websites. |
| github_ | Sunlight | committee-membership- | | All current House, Senate |
| committee_ | Foundation | current.yaml | | and Joint committee |
| membership | | | | memberships. |
| github_roll | Sunlight | The United States House | | A scraper that collects all |
| | Foundation | and Senate websites via | | roll call votes of the current |
| | | votes.pyc script provided by | | congress. |
| | | the Sunlight Foundation | | |
| github_roll_ | Sunlight | The United States House and | | A scraper that collects the |
| votes | Foundation | Senate websites via | | votes each member cast |
| | | votes.pyc script provided by | | on each roll call vote. |
| | | the Sunlight Foundation | | |
| pt_events | Sunlight | events.csv | | A list of fundraising events |
| | Foundation | | | held for legislators. |
| pt_ | Sunlight | beneficiaries.csv | | A list linking fundraising |
| beneficiaries | Foundation | | | events to beneficiaries of |
| | | | | those events. |
| pt_other_ | Sunlight | omcs.csv | | A list of members |
| members | Foundation | | | sponsoring fundraising |
| | | | | events. |
| lw_news_ | Proprietary | lw_news_attributes | | A list of news events in |
| attributes | | | | which legislators have been |
| | | | | involved. |
| lw_news_ | Proprietary | lw_news_members | | A list of members involved |
| members | | | | in each news event. |
| lw_caucuses | Proprietary | lw_caucuses | | A list of Congressional |
| | | | | caucuses. |

| | | | |
|---|---|---|---|
| lw_caucus_ | Proprietary | lw_ caucus_members | A list of members |
| members | | | associated with each |
| | | | Congress. |
| lw_ | Proprietary | lw_casualties_[congress] | A list of members who |
| casualties_ | | | have announced |
| [congress] | | | retirement. |

**FEC file names end with the election cycle year

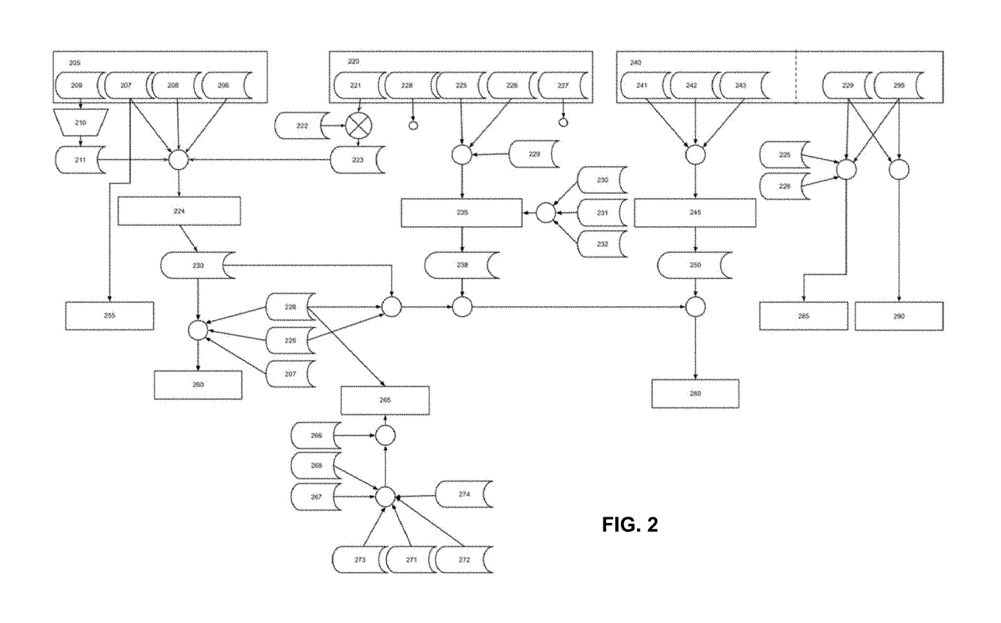

The data 101, 102, 103, 104, 105 is ingested into the analytic platform 100, then scrubbed 110 (as will be described in more detail below) to ensure that all fields required for database querying are complete and organized to optimize the querying process. Once the data has been scrubbed, it is stored in a standard enterprise database 120 using MySQL. The process of ingesting, scrubbing and storing the data according to various example aspects of the invention is described in more detail in FIG. 2.

FIG. 2 shows in detail how the present invention can integrate and analyze data from multiple sources. This data may be ingested periodically, for example, monthly, weekly, daily, nightly, hourly, by minute or by second, and stored in an open-source relational database management system based on structured query language (“SQL”), for example, a MySQL database. In certain non-limiting example aspects, the data may be ingested by using a data-loading tool that takes the data in its published format (XML, YAML, CSV), checks the data for referential integrity to ensure that there is no incomplete data and then transforms the data fields of the published data to the structure of the SQL database according to a predefined mapping, and then loads the data into the database.

One example of a dataset to be integrated includes data from the FEC on contributions from one legislator to another or from a PAC to a legislator. The ingested FEC data 205 may include one or more tables containing candidate data (fec_cn) 206, campaign committee data (fec_cm) 207, contributions from one campaign committee to another such as from a political action committee to a candidate's fundraising committee (fec_pas2) 208, and linkages between candidates and their fundraising committees (fec_ccl) 209.

In analyzing data to map relationships, it is important to note that contributions are not made to the candidates themselves, but rather to a candidate's campaign committee, which, when mapping relationships, can be considered to be surrogates for the candidates themselves. It is thus critical in database analysis to make a unique linkage between a candidate's ID number and a campaign committee ID number.

However, making this unique linkage is made difficult by two factors. First, candidates may have more than one candidate committee. Second, it is common for a candidate committee to be active over more than one cycle. Because of this, often it is not possible to run a traditional database query that will identify, without double-counting, the total contributions a candidate committee (and thus a candidate) has received from a PAC or another candidate committee.

For example, consider the following hypothetical: John Doe, Representative from New York's 14th Congressional District, is associated with two candidate committees: “Doe for Congress” (assigned FEC ID number C00XXXXXX) and the “Doe Leadership Fund” (C00YYYYYY). While the “Doe Leadership Fund” is primarily intended to solicit funds that Doe distributes to other candidates, from the perspective of tracking relationships between Doe and various organizations and individuals, the two funds are the same (and are a proxy for Doe himself).

However, when we query transactions between a candidate (i.e., John Doe) to other candidates, it will match up all committees that belong to John Doe, once for each committee and each cycle, duplicating the results.

This problem is resolved by concatenating the candidate committee lists provided by the FEC for each election cycle into one large list and extracting out the unique pairs while ignoring the election cycle in which the pair was generated 210. The resulting list of pairs uniquely identifies which candidate is linked to each committee regardless of the election cycle in which the link was originally defined. This results in the creation of a new table, fec_ccl_distinct 211, which assigns a single ID number, C00338954, for both candidate committees associated with Doe.

The FEC data covers the entire universe of declared candidates for the House, the Senate and the Presidency, including the many that do not make it past their party's primary. In the current embodiment of the invention, analysis is intentionally limited to the subset of candidates who are current Congressional officeholders and thus have control over legislation and appropriation. The analytical potential of the contribution data is increased by integrating it with current legislators' voting records, bill sponsorship and co-sponsorship activity, Congressional committee memberships and similar attributes.

A second example of data to be integrated is data concerning current members of the legislature. In one non-limiting example examining members of the U.S. Congress, The Sunlight Foundation collates data on Members of Congress from numerous public sources and makes that data available in open-source format. The data maintained by the Sunlight Foundation on bills and legislators 220 may be ingested periodically (e.g., nightly) and stored in the database 120. The data may include, for example, tables on legislators (github_legislators) 225, bills introduced for consideration (github_bills) 226, lists of Congressional committees (github_committees) 227, legislator terms (github_legislators_terms) 228, roll call votes (github_roll) 229, bill sponsors (github_bills_sponsors) 233, bill cosponsors (github_bills_cosponsors), bill subjects (github_bills_subjects) 232 and the actual votes cast by legislators (github_roll_votes) 295. The analytical utility of the FEC data and the Sunlight Foundation data is increased by linking them together. However, the Sunlight Foundation table providing the FEC linkage data (github_legislators_fec) 221 may have incomplete listings of ID numbers assigned to candidates by the FEC, which may hinder the system's ability to link the two data sets. To remedy this, the present invention can, for example, create a temporary table in MySQL through a standard command known to those versed in the art as a “view,” which combines the Sunlight Foundation's information on legislator FEC ID numbers 221 with a manually maintained table of FEC ID numbers (github_legislators_fec_manual) 222 to create a complete and usable table (github_legislators_complete) 223.

After this preparatory ingestion and scrubbing of the data tables, multiple data tables may be joined to simplify later analysis. In certain example aspects, a database query (reload_fec_pas2_extended.sql) 224 may be used to join data from the scrubbed linkage table connecting candidates to campaign committees (fec_ccl_distinct) 211, and tables with data of campaign committees (fec_cm) 207, contributions from one campaign committee to another (fec_pas2, fec) 208, candidate information (fec_cn) 206, as well as the scrubbed table 223 providing linkage with the legislator and bill data from the Sunlight Foundation. The result of the query is a single table, fec_pas2_extended 230 that can be readily queried during analysis.

In certain example aspects, a similar integration of multiple tables can be conducted regarding the legislator and bill data. The data combined may include, for example, tables on legislators (github_legislators) 225, bills (github_bills) 226, roll call votes (github_roll) 229, bill sponsors (github_bills_sponsors) 233, bill cosponsors (github_bills_cosponsors) 231 and bill subjects (github_bills_subjects) 232. A query (reload_github_bills_blended.sql) 235 may be used to combine data from these tables into a single table (github_bills_blended) 238 that can be readily queried during analysis.

A third example of data to be integrated includes data regarding fundraising events that legislators may sponsor or co-sponsor for each other; this data, along with data on sponsorship and cosponsorship of bills, helps to map relationships between legislators. There are numerous metrics that can be used to map relationships between legislators. These events are gathered by the Sunlight Foundation's open source Political Party Time application programming interface (“API”) on fundraising events held for legislators 240 may be ingested periodically (e.g., nightly) and stored in the database 120. These tables may include, for example, data on fundraising events (pt_events) 241, the legislators benefiting from such events, (pt_beneficiaries) 242 and other legislators who are cosponsoring the event (pt_other_members) 243. A database query (reload_pt_events_extended.sql) 245 may be used to combine data from these tables into a single table (pt_events_extended) 250 that can be readily queried during analysis.

A fourth example of data to be integrated concerns data that provides additional context for each legislator. These attributes might include open-source data such as congressional committee memberships (github committee_membership) 266, but it may also include data that is connected manually in proprietary databases. That data may include a list of news events (lw_news_attributes) 267 in which members (lw_news_members) 268 have been involved, a list of legislators who have vacated their seats before the end of the term or who have announced retirement or lost a bid for re-election (lw_casualities_[congress]) 273, a list of Congressional caucuses (lw_caucuses) 271 and caucus members (lw_caucus_members) 272.

Having ingested, scrubbed and combined similar datasets, database queries can be generated that can be used as inputs for the data analysis. In certain example aspects, the queries used during the analysis may include: a query generating data regarding the attributes of various political action committees (pac_attribute_data.sql) 255; a query generating data of contributions from political action committees to candidate committees (pac_mem_edges.sql) 260; a query generating data regarding various attributes of legislators (mem_attribute_data.sql) 265, a query generating data showing relationships between legislators established by sponsorship and cosponsorship of bills and sponsorship and cosponsorship of fundraising events (mem_mem_edges.sql) 270, a query generating the attributes of the votes taken that meet certain criteria to filter out trivial or procedural votes not of interest (vote_attribute_data.sql) 280 and a query generating data on the individual votes cast by each legislator (impt_rcv_discrete.sql) 275.

Known systems and processes of analyzing legislative events are hindered by two particular issues relating to the structure of queries that are remedied by the present invention. The first issue is that legislative events are often viewed at a single moment in time rather than a series over time. Analyzing legislative events as a time series allows users to see patterns and movement within the group as a whole. In various example aspects, the present invention addresses this issue by taking a data universe starting with datetime to and ending with datetime tₙ, dividing the time period into n sections (t₀, tₙ) and then generating a series of datasets at each point tₓ where x ranges from 1 to n. The datasets can then be analyzed in sequence so that patterns over time can be detected.

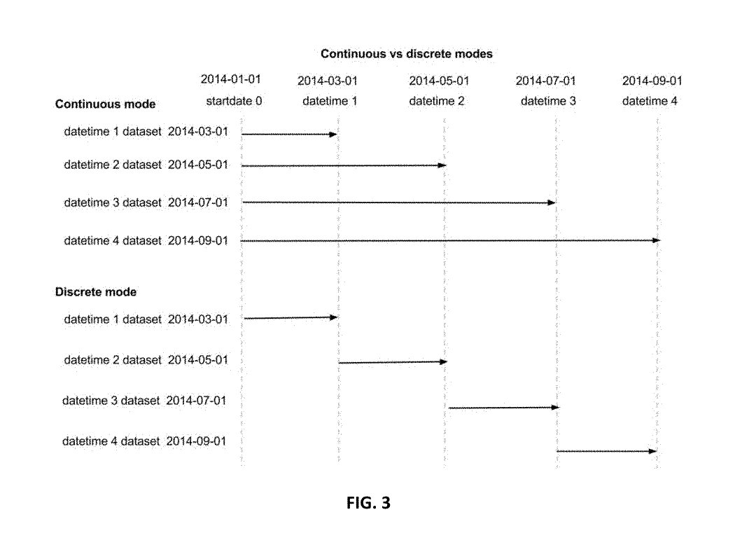

According to various example aspects of the invention, the datasets 1 to n generated from the data universe can be either “discrete” or “continuous.” In continuous mode, each dataset begins at to and ends at tₓ, with x ranging from 1 to n. In discrete mode, the datasets do not overlap; each dataset x runs from tₓ₋₁ to tₓ. FIG. 3 is a diagram showing continuous and discrete modes in accordance with various example aspects of the invention. The data universe in FIG. 3 runs from Jan. 1, 2014 to Sep. 1, 2014. In this example, the data universe first is given five reference points:
a. t₀=Jan. 1, 2014
b. t₁=Mar. 1, 2014
c. t₂=May 1, 2014
d. t₃=Jul. 1, 2014
e. t₄=Sep. 1, 2014

In continuous mode, the datasets include the following data:
a. Datetime 1 dataset: from Jan. 1, 2014 to Mar. 1, 2014
b. Datetime 2 dataset: from Jan. 1, 2014 to May 1, 2014
c. Datetime 3 dataset: from Jan. 1, 2014 to Jul. 1, 2014
d. Datetime 4 dataset: from Jan. 1, 2014 to Sep. 1, 2014

In this way, each dataset shows the cumulative state of legislative events from to to each of the four points t₁, t₂, t₃ and t₄.

In discrete mode, the datasets are comprised of the following data:
a. Datetime 1 dataset: from Jan. 1, 2014 to Mar. 1, 2014
b. Datetime 2 dataset: from Mar. 1, 2014 to May 1, 2014
c. Datetime 3 dataset: from May 1, 2014 to Jul. 1, 2014
d. Datetime 4 dataset: from Jul. 1, 2014 to Sep. 1, 2014

In this way, it is possible to compare and contrast discrete time blocks within a data universe in order to highlight differences in legislative events in each period of time.

The second issue that known systems and processes have when analyzing legislative events involves filtering based on minimum committee contributions, minimum number of co-sponsorships or similar metrics. If a user sets a contribution filter to exclude contributions below a certain level, that same filter will be applied at each point in time tₓ, creating a relatively high filter threshold at earlier points in time and a lower filter threshold at later points in time. For example, if the filter for contributions is set at $20,000 for each of the four continuous datasets discussed above in connection with FIG. 3, in order to be included in the January 1 to March 1 dataset, a political action or candidate committee would have to have donated $20,000 during that time period. This is a much more stringent filter than for the January 1 to September 1 dataset, in which a committee would have four times as much time to have contributed $20,000 to a given candidate and thus be included in the analysis.

Referring now to FIG. 1, in various example aspects, the present invention resolves this issue by enabling the user to set parameters 130 over the entire time period (t₀, tₙ). These parameters define the initial query 131 against the database 120. The results of the query are stored in a temporary filtered database 135. As an example, if the filter for political action or candidate committee contributions to member candidate committees is set at $20,000, all contributions from committee A to member B are included when the total of such contributions from A to B during the time period (t₀, tₙ) is equal to or greater than $20,000.

The user-defined parameters 130 then generate a secondary query 132 against the temporary filtered database 135 that produces the datasets 140 which are used for the analysis. These datasets are defined to reflect the temporal partitioning described with respect to FIG. 3 above. For example, Dataset 1 could comprise data from Jan. 1, 2014 to Mar. 1, 2014, Dataset 2 could comprise data from Mar. 1, 2014 to May 1, 2014, and so on.

In various example aspects, a central operation of the invention is hierarchical clustering 145. Divisive hierarchical clustering enables the universe of data points to be divided into two groups based on the similarity of a particular attribute. This division can be calculated using one of several approaches, which involve a) different methods of calculating the distance between every pair of points based on that attribute, and then b) comparing the distances between each pair and defining groups of points according to one of several “linkage criteria” which are well known to those versed in the art. Each of the two groups that results from this clustering is further divided into two groups, with the process continuing until each cluster has been reduced to functionally identical data points or each cluster consists of an individual data point. Alternatively, the process can unfold in reverse from the “bottom up,” using agglomerative clustering. The clustering may be based on, for example, the computation of a matrix that records the dissimilarity of each pair in the data universe on a scale from 0 to 1.

In certain example aspects, dissimilarity matrices and the resulting hierarchical clustering is conducted on the following datasets:
a. on members, based on dissimilarity in voting;
b. on votes, based on dissimilarity in the vote cast by each member;
c. on political committees, based on dissimilarity of contributions;
d. on members, based on dissimilarity of political committee contributions.

Because of the different nature of the datasets, the choice of which dissimilarity formula to use is crucial (see “An Introduction to Cluster Analysis for Data Mining,” pp. 9-13, http://www-users.cs.umn.edu/^{˜}han/dmclass/cluster_survey_10_02_00.pdf). Consider two entities, p and q, that are being compared. Assume further that the comparison is binary, such as whether members p and q voted “yea” or “nay” on a bill, or whether or not PAC p and PAC q have contributed to a particular candidate committee. In examining all instances in a dataset, we may express the relationship between the behavior of p and q as follows, in which “0” represents not making an action and “1” represents making that action:
a. M₀₁=the number of instances in which p was 0 and q was 1 (that is, member p voted “nay” and member q voted “yea,” or PAC p did not make a contribution to candidate committee x and PAC q did make such a contribution).
b. M₁₀=the number of instances in which p was 1 and q was 0.
c. M₀₀=the number of instances in which p was 0 and q was 0.
d. M₁₁=the number of instances in which p was 1 and q was 1.

Those of ordinary skill in the art will recognize that in the case of two members of a legislature voting on the same group of bills, the similarity between them can be captured through use of the simple matching coefficient (SMC), which is calculated as follows:

SMC=(M₁₁+M₀₀)/(M₀₁+M₁₀+M₁₁+M₀₀).

However, the libraries used by the R programming language require relationships expressed in matrices to be expressed as dissimilarities. This problem is easily rectified by transposing the simple matching coefficient into a dissimilarity coefficient d through the formula

d=1=SMC.

The simple matching coefficient is appropriate in the above case because there is useful information contained in all four of the possible outcomes enumerated in [0044]. In particular, similarity of views may be inferred from M₀₀, the number of cases in which both legislators p and q fail to vote Yea (that is, vote Nay) on a bill.

However, in the case when p and q are different PACs, because there are hundreds of candidate committees to which each PAC could potentially contribute and most PACs contribute to only a fraction of that, the mere fact that two PACs fail to contribute to a given candidate committee x carries little useful information. Therefore, a different coefficient than SMC must be used.

Those of ordinary skill in the art will recognize that in this case, the Jaccard coefficient J is more appropriate, as it removes M₀₀ from both the numerator and denominator:

J=(M₁₁)/(M₀₁+M₁₀+M₁₁).

In the denominator, the universe has been constrained to only those candidate committees to which at least one of the two PACs p and q have contributed.

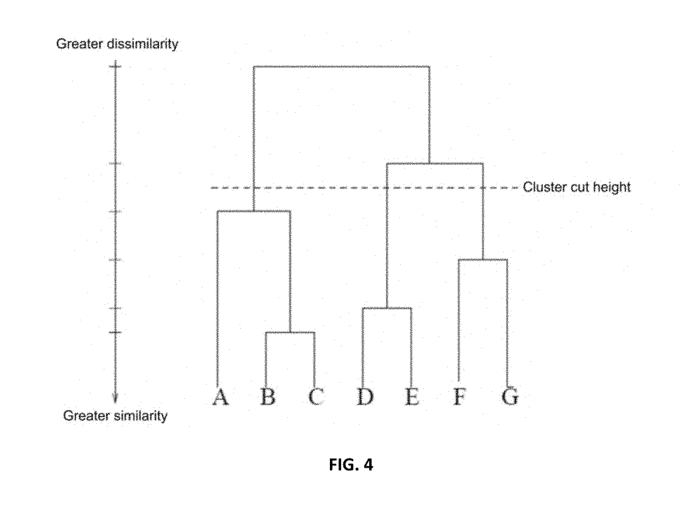

Hierarchical clustering is often represented in a dendrogram, which maps cascading clusters and sub-clusters as a tree, as shown in FIG. 4. In a dendrogram, clusters are defined as all points having dissimilarity at or below a given value represented in the figure as height h. Decreasing cluster height creates smaller clusters of more similar data points, while increasing cluster height creates larger clusters of more dissimilar data points, similar to zooming in and zooming out of a map. Referring to the example shown in FIG. 4, if the height h is indicated by the dotted line, the entities A through G are segmented into three clusters: [A, B, C], [D, E] and [F, G].

It should be noted that there are two adjustments that need to be made to the member voting records in order for the members to be clustered correctly. Review of the definition of the simple matching coefficient given in [0048]-[0049] shows that it assumes data will be given in binary form. This raises the question of how to handle cases in which members, rather than voting “Yea” (1) or “Nay” (0) vote “Present” or are absent. Because these cases are relatively infrequent and contain little or no information regarding the voting similarity of two members, these votes are discarded.

A more challenging problem comes from the case where, at a given point in time, there is insufficient information to calculate the dissimilarity between two legislators (for example, if both legislators voted present or absent in all votes in which they were members, or if one member joined the legislature after it began, leading to a string of votes for which no pairing could be made). In this case, the R script calculating the dissimilarity between two such legislators would generate an “NA.” The problem arises from the fact that the R library cannot calculate clusters with “NA” as an input value. This problem is resolved by replacing “NA” with the value 0.5, which is the neutral middle between dissimilarity=0 (all Yea/Nay votes cast by the two members are the same) and dissimilarity=1 (no Yea/Nay votes cast by the two members are the same).

One challenge in using hierarchical clustering in data interpretation is in selecting an appropriate cluster height. A user may only know which height is most appropriate after trial and error, which can involve a time-consuming, iterative analysis of the dataset using various cluster heights. In various example aspects, the present invention addresses this issue by repeating the cluster analysis in a loop, generating separate analyses over a range of predetermined cluster heights h₀ to hₙ, and allowing the user to choose which cluster height provides the most appropriate cluster resolution for the question at hand.

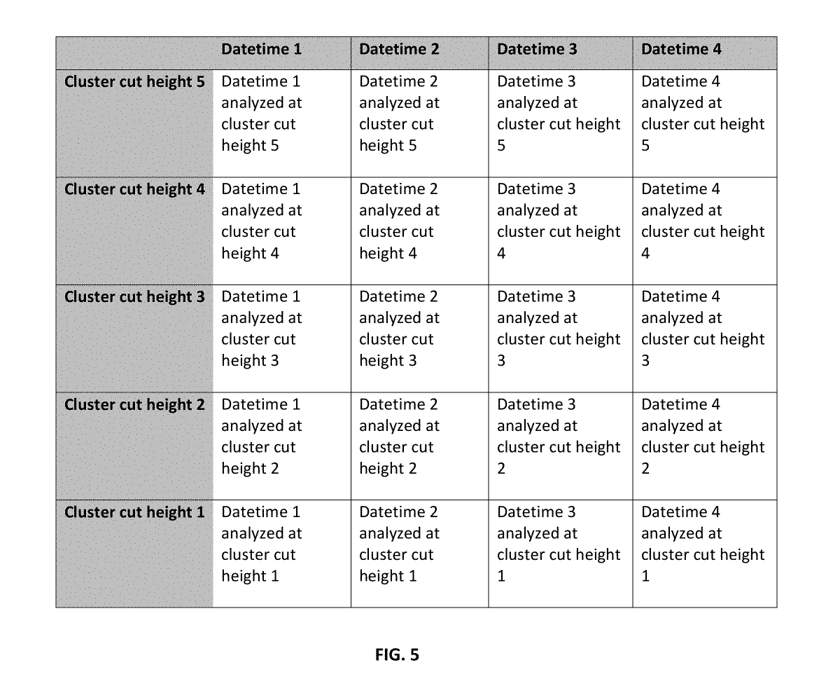

Referring to FIG. 1, the combination of generating data at specific points across a time period ranging from t₀ to tₙ and analyzing each dataset tₓ across cluster heights ranging from h₀ to hₙ results in a time/cluster height data array 150. The structure of that array is shown in FIG. 5, in which each collection of data stored in the array depicts legislative events at a certain point in time tₐ and at a cluster height h_{b}.

In the same way in which a well-chosen visualization can provide insight into a relationship between data in a dataset that is difficult to obtain without the visualization, groups of visualizations can be used on the same or related data to provide insight that a single visualization cannot. Thus, in various example aspects, the present invention may incorporate one or more visualization models, as will be described in more detail below.

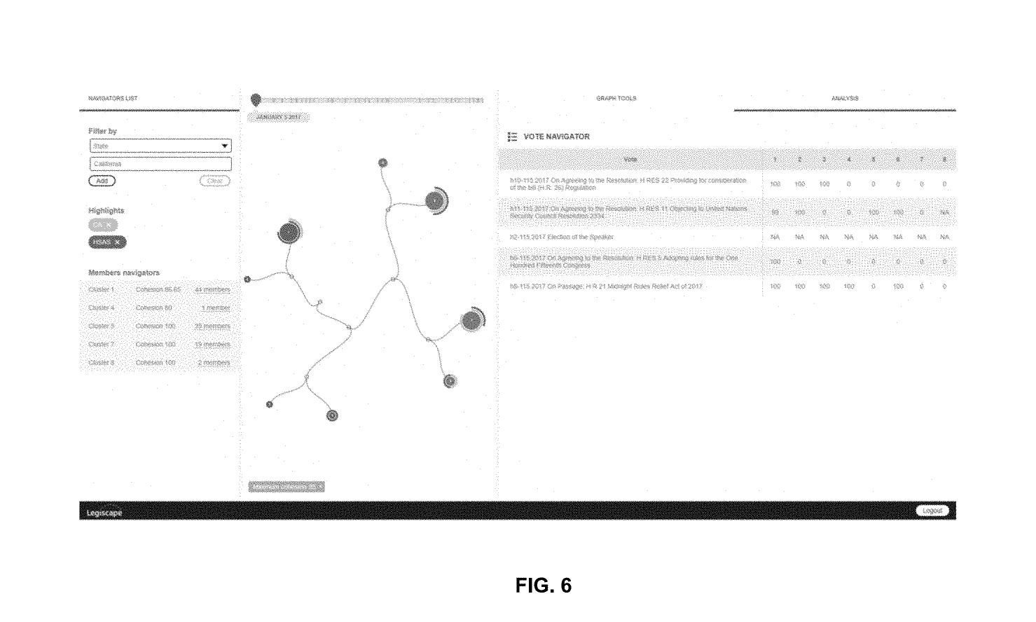

In seeking to understand legislative behavior, a user may wish to view the cluster analysis at various points in time. In addition, when viewing data for a given point in time, the user may wish to view the cluster analysis at different cut heights, providing clusters of greater or lesser levels of similarity in order to understand the nature of differences in various legislative events. Referring again to FIG. 1, the time/cluster height data array 150 allows for a matrixed visualization 160 in which the user may navigate, by means of slider controls, to various data visualizations across times from t₀ to tₙ and at cluster heights from h₀ to hₙ. Each distinct matrix point (tₐ, h_{b}) can be visualized 161 as a clustered hierarchy. FIG. 6 provides an example of this visualization according to certain aspects of the invention.

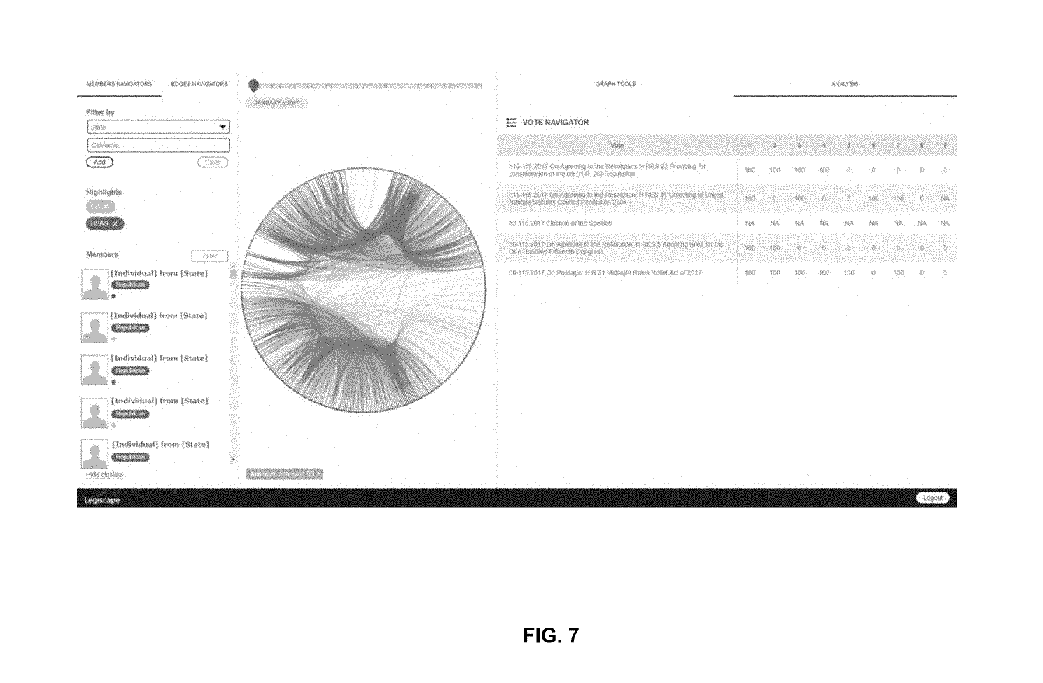

While applying a tree-view visualization to dendrograms provides intuitive visualization regarding clusters and sub-clusters, it is more difficult to visualize specific relationships between members. To do so, a user can switch to a node-link diagram as shown in FIG. 7, in which relationships can be represented by edges between nodes. The clusters of FIG. 6 are shown in FIG. 7 by grouping members of the same cluster adjacent to each other.

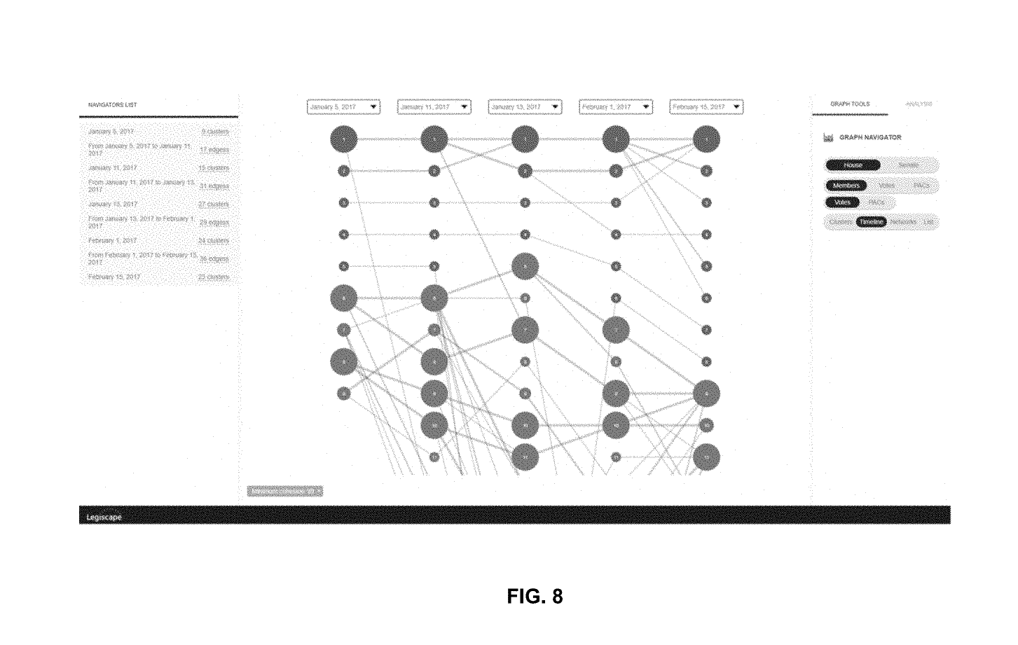

Understanding how clusters change over time can be facilitated through the timeline visualization shown in FIG. 8. This visualization shows each cluster as a single node, and the various clusters from a given datetime tₓ as a column of nodes. The change in cluster composition is shown by comparing in the tree-view hierarchies at a given cluster height for each datetime tₓ. The movement of members between clusters at successive points in time selected by the user can thus be visualized as edges in the network visualization of FIG. 8.

In the same manner in which tree-view hierarchies and timelines can be constructed to analyze members of a legislature, the same visualizations can be used to analyze the votes of the legislature (based on how each member voted on the measure) and political action committees (based on contributions to members). In addition, members can be clustered based on similarity of their political action committee contributions rather than on the similarity of their votes.

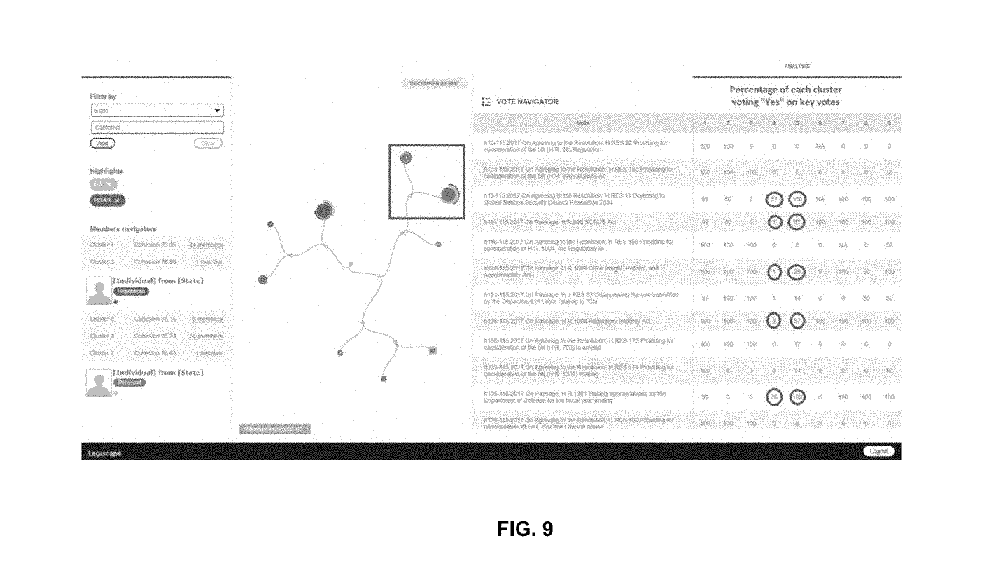

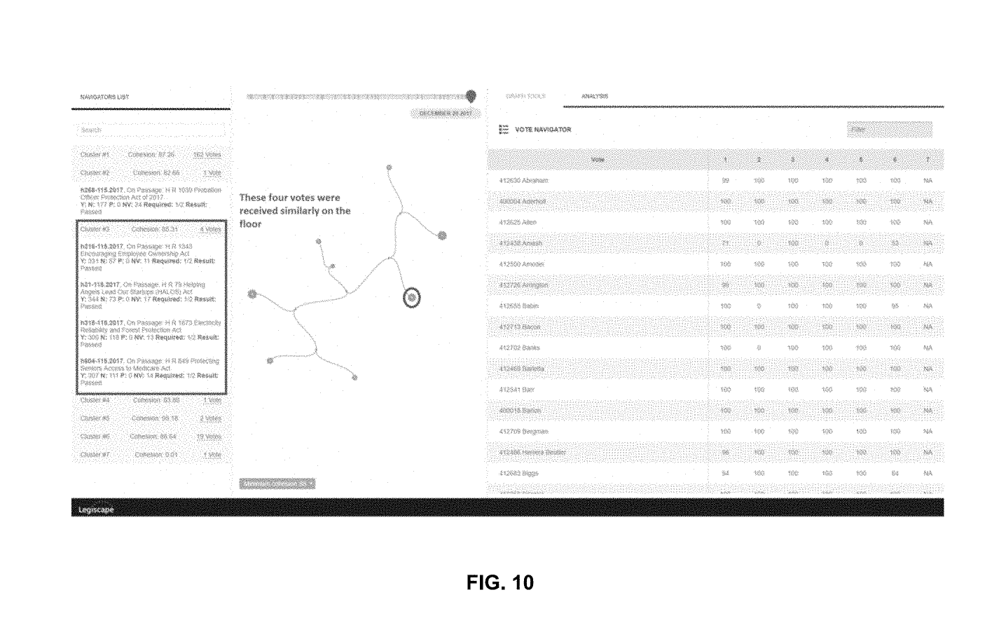

In addition, referring to FIG. 1, various analyses 162 can be conducted and exposed in conjunction with each visualization 161. Referring to FIG. 9, in certain example aspects, in the visualization of members clustered by votes, the analysis may include a tabular representation of the percentage of members in each cluster who voted “Yea” on each bill in that dataset. This analysis allows users to pinpoint which votes define the difference between neighboring clusters. Similarly, referring to FIG. 10, in the visualization of votes clustered by how they were voted upon, the analysis could include the percentage of votes within a cluster for which each member voted “Yea.” This analysis provides insight into the possible reception of proposed legislation by providing the user with discrete groups of past votes against which the proposed legislation can be compared.

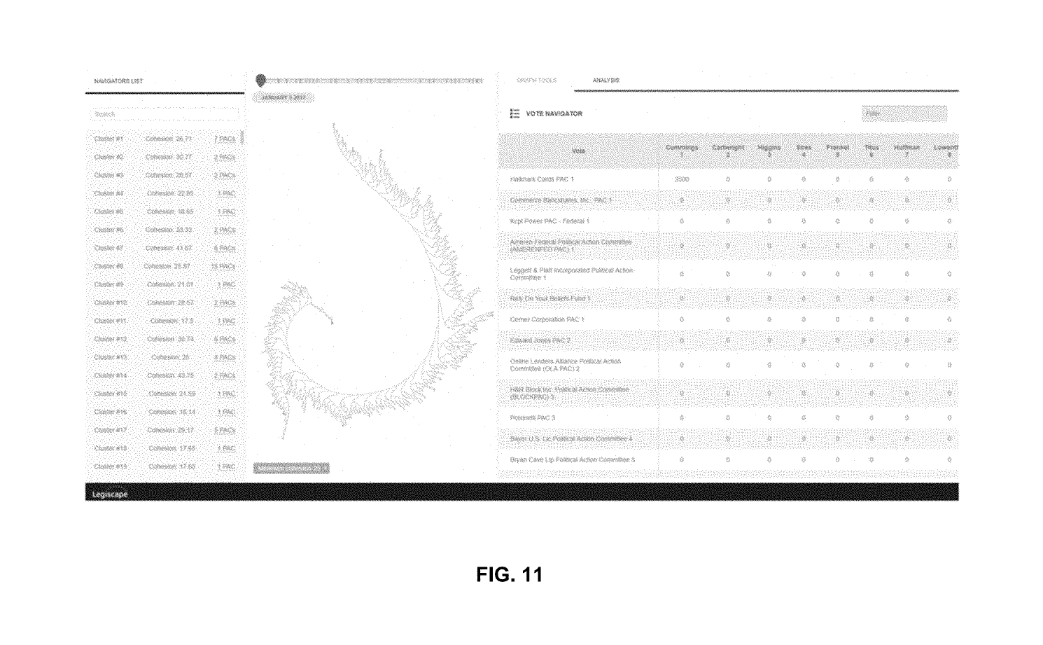

Referring to FIG. 11, in the visualization of political action and candidate committees clustered by similarity of members to whom contributions were made, the analysis could include a list of all members who have received contributions from committees in a given cluster, and the amount of the contribution.

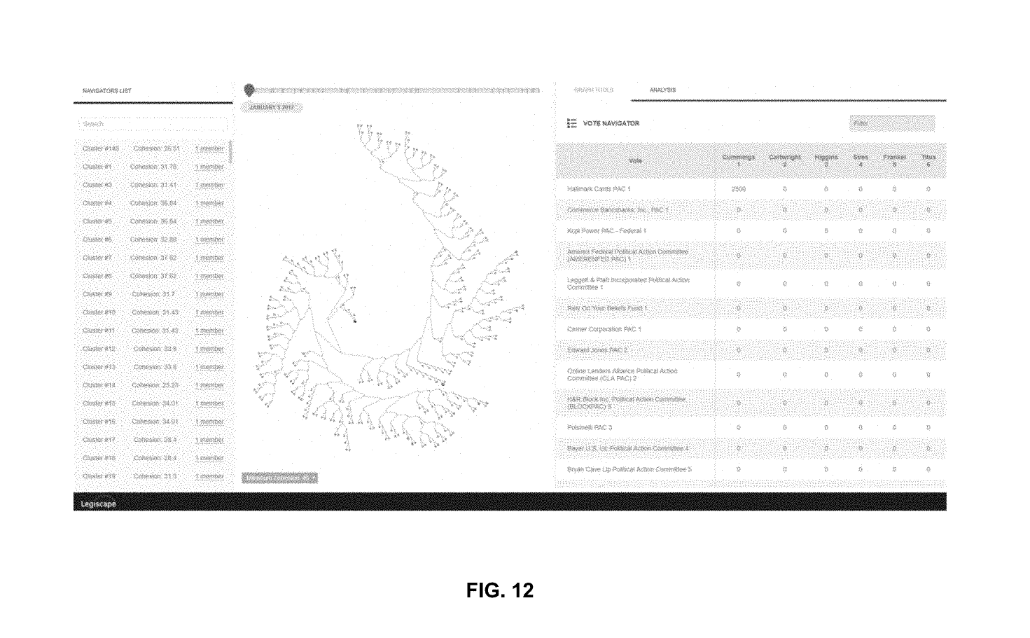

As shown in FIG. 12, in the visualization of members clustered by donations received from political action and candidate committees, the analysis could include a list of all political action and candidate committees that have contributed to the members in that cluster, and the amount of the contribution.

Referring again to FIG. 1, because various attributes have been attached to each node, users are able to define various parameters 155 to filter or highlight in the matrixed visualization 160; the filtering or highlighting will be manifest in the cluster visualization 161. For example, in certain aspects, a user could highlight all nodes containing members of the legislature who represent California and who are also members of the legislature's Armed Services Committee. The percentage of members within each cluster with such attributes can be indicated by color-coded arcs surrounding the relevant clusters. Such a visualization is shown in FIG. 9.

In certain aspects, taking the example of members clustered by votes, this visualization and analysis of data allow users to objectively identify voting coalitions and sub-coalitions, quantify the cohesiveness of those coalitions (via the cluster height) and identify similarities and differences in voting between clusters. Further, users can track how members who share certain attributes are distributed among clusters, and the interaction between members within and across clusters, such as co-sponsorship of bills or contributions to each other's campaign committees. Further, users can objectively track over time the formation and dissolution of coalitions and the movement of members between coalitions.

Similarly, taking the example of political action and candidate committees clustered by contribution, this visualization and analysis of data allow users to objectively identify coalitions and sub-coalitions among such committees, quantify the cohesiveness of those coalitions (via the cluster height) and identify similarities and differences in contributions between clusters. Further, users can track how committees that share certain attributes are distributed among clusters, and users can objectively track over time the formation and dissolution of committee coalitions and the movement of committees between coalitions.

Furthermore, taking the example of floor votes clustered by individual member votes, this visualization and analysis of data allow users to objectively identify which votes are similar to each other in terms of their reception by the voting body, quantify the level of that similarity (via the cluster height), and identify similarities and differences in how each member voted on each cluster. Moreover, users can track how floor votes that share certain attributes are distributed among clusters and users can objectively track over time the formation and dissolution of groupings of similar votes and the movement of votes between those groupings over time.

This objective analysis of legislative events will allow those seeking to advance a legislative agenda to create more effective strategies for assembling member coalitions, predicting the outcome of votes and marshaling support from interest groups.

Referring again to FIG. 1, in certain example aspects, the core functionality of the analytic platform 100 allows various attributes to be stored and attached to the various nodes (for example, members, floor votes, campaign committees). The usefulness of this capability is greatly extended with the ability to create attributes based on news events and assign them to nodes directly from web pages. This can be accomplished in the annotation extension 170. The annotation extension is a browser extension that enhances the capabilities of a standard web browser such as Google Chrome®. When the browser navigates to a web page 171, the text may undergo text extraction 172. In certain aspects, the annotation extension queries the database to extract a list of current legislators and key attributes such as party affiliation. Furthermore, a natural language processing module 173 can match the text of the web page with the list of current legislators, and send a list of identified named entities back to the text controller.

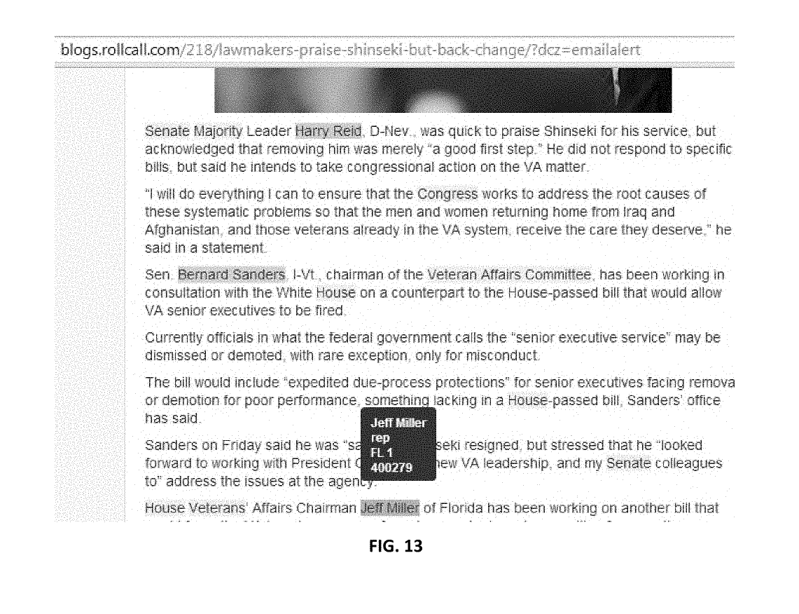

Based on the data from the natural language processing module, the extension can then highlight the named entities in the browser 174. Referring now to FIG. 13, in various example aspects, the text is highlighted with a color signifying party membership. When a user hovers over the highlighted name, a pop-up display can provide key attributes including, for example, name, party and chamber so that a user may confirm a correct match.

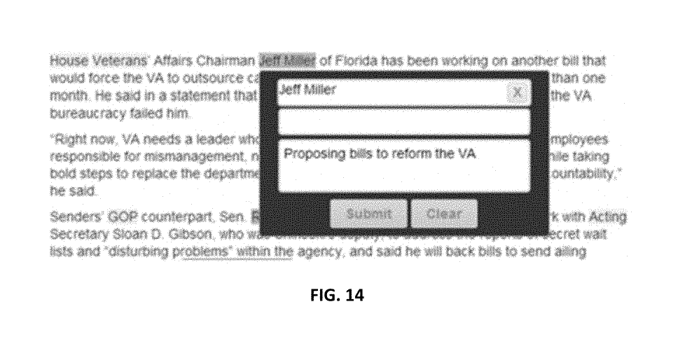

As shown in FIG. 14, by clicking on a highlighted name, a different pop-up window may appear that includes the highlighted name and allows the user to create a news attribute 175, such as “Proposing bills to reform the Department of Veterans Affairs.” The user can then click on additional names in the article to assign that same attribute. When the user submits this information, it is entered into the member attribute table in the database 120. “Proposing bills to reform the Department of Veterans Affairs” thus becomes an attribute that can be searched and highlighted in the visualization. This allows users to record and track ongoing positions taken by members and their involvement in news events, and to plot that information against the cluster analysis.

As described above, the present invention addresses various issues with known systems and methods for analyzing legislative events by providing an objective platform for such analysis that can include: a) the identification of voting coalitions and sub-coalitions among members, quantification of the cohesiveness of each cluster or sub-cluster, and identification of the votes which divide one cluster from another, b) the identification of networks within and between coalitions based on activity such as cosponsoring legislation, contributing to other member's campaigns or sponsoring fundraising events for other members, c) the ability to track how clusters and sub-clusters of legislators change over time and how legislators move from cluster to cluster, d) the ability to assign attributes to members based on unfolding news events (such as taking a particular position on an issue) and then see how those members with given attributes are distributed within the voting coalitions, e) the ability to cluster legislators based on the political action committees and candidate committees that have contributed to their campaigns, and track changes to those clusters over time, f) the ability to cluster those political action committees and candidate committees according to the legislators to whom they contribute, and g) the ability to cluster votes based on how they were received by the legislature and track changes to those clusters over time.

The availability of such an objective platform for analyzing and visualizing legislative events will have meaningful application in a number of areas.

Those who have a direct or indirect role in the legislative process—members of the legislature and their aides, members of the executive branch and the legislative aides of the executive branch, lobbyists and other advocates—will now be able to develop strategies based upon an objective picture of the various coalitions, sub-coalitions and networks within the legislature. This will allow their efforts to pass or defeat pending legislation to be more efficient and effective.

Those raising funds for candidates from political action committees will be able to more easily identify other likely sources of contributions.

Investors and hedge funds whose investments are made based in part on forecasts of legislative activity will now be able to make those forecasts more objectively and with greater confidence.

Media outlets, political scientists, advocates and others focused on defining and shaping public opinion will be able paint more accurate pictures of legislative coalitions and networks.

Other jurisdictions whose own security, trade and economic policies are affected by the legislature being analyzed will have a powerful tool for anticipating that legislature's action, and where permitted, working to effect desired outcomes.

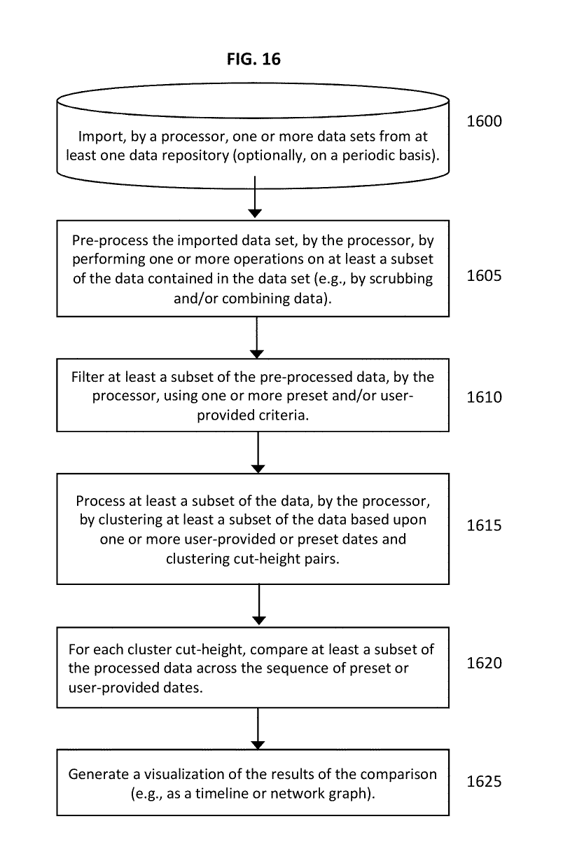

Referring to FIG. 16, the systems and methods according to various example aspects of the invention may include a computer system 1500 with at least a processor 1505, one or more memory devices and/or an interface for connection to one or more memory devices 1510, which would include random operating memory (ROM) 1515 running the system's basic input/output operating system (BIOS) 1520 and random access memory running the system's operating system, such as CentOS 6. The memory devices would also house the scripts and programs 1525 that run at each step in the process herein described as well as house the data 1530 generated by those scripts and programs.

The system would also include hard drive storage 1540 comprised of multiple general-purpose hard disk drives configured as a redundant array of independent disks, in a configuration commonly known as RAID-1. The hard disk drive storage would include the system's operating system, such as CentOS 6 1545, the various applications needed to operate the invention, including R and PHP 1550 and a relational database 1555 which would store the range of input data used by the invention.

The system would also include a graphics card 1560 that would allow information from the system, including the various analyses generated by the invention, to be displayed to the user on a monitor 1565. The system would also include one or more network cards 1570 that would allow connection to the Internet 1575.

The system will also include a data bus 1590 for internal and external communications between the various components, including input and output interfaces for connection to external input devices 1580 such as a pointing device, keyboard or printing device; and output devices 1585 in order to enable the system to receive and operate upon instructions from one or more users or external systems.

The processor may be arranged to perform the steps of a software program stored as program instructions within the memory device. The program instructions may enable methods according to various example aspects of the invention to be performed. The program instructions may be developed or implemented using any suitable software programming language and toolkit, such as, for example, a hypertext preprocessor (“PHP”). The program, in turn, can execute various files of computer code written in a code suitable for that task. For example, scripts that query the database can be written in a code such as PHP in combination with MySQL, scripts that execute the computational code can be written in a computer language, for example, a statistical computer language such as R, and the script managing the visualization display can be written in a computer language such as Python in combination with JavaScript. Each script may incorporate such open-source libraries as are necessary, for example, JavaScript may access d3.js, and R may incorporate libraries which execute standard components of hierarchical clustering.

In certain aspects, the output of the program can be accessed through a standard web browser, such as Google Chrome®, which can be viewed on a standard computer monitor. The browser's print function can allow output to be printed. Alternatively, there may be a specially designed module to facilitate printing of the program's output in an efficient and user-friendly format. The output module also may be an interface that enables the output data to be interfaced with other data handling modules or storage devices.

FIG. 17 summarizes the workflow of this embodiment of the invention.

Step 1600: Data is imported from one or more data repositories, optionally on a periodic basis.

Step 1605: Data contained in the data sets is pre-processed and/or combined using various pre-processing operations (e.g., scrubbing the data).

Step 1610: At least a subset of the pre-processed data is filtered according to one or more pre-programmed and/or user-provided criteria.

Step 1615: Process at least a subset of the data, by the processor, by clustering at least a subset of the data based upon one or more user-provided or preset dates and clustering cut-height pairs.

Step 1620: For each cluster cut height, compare at least a subset of the processed data across the sequence of preset or user-provided dates.

Step 1625: Generate a visualization of the results of the comparison (e.g., as a timeline or network graph viewable in an internet browser or other software interface).

In the interest of clarity, not all of the routine features of the exemplary aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of restriction, such that the terminology or phraseology of the present specification is to be interpreted in light of the teachings and guidance presented herein, in combination with the knowledge available to a person of ordinary skill in the relevant art(s) at the time of invention. Moreover, it is not intended for any term in the specification or claims to be ascribed an uncommon or special meaning unless explicitly set forth as such in the specification.

The various aspects disclosed herein encompass present and future known equivalents to the known structural and functional elements referred to herein by way of illustration. Moreover, while aspects and applications have been shown and described, it would be apparent to those skilled in the art having the benefit of this disclosure that many more modifications than those mentioned above are possible without departing from the inventive concepts disclosed herein. For example, one of ordinary skill in the art would readily appreciate that individual features from any of the exemplary aspects disclosed herein may be combined to generate additional aspects that are in accordance with the inventive concepts disclosed herein.

Although illustrative exemplary aspects have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A computer-implemented method for generating a visualization of legislative events, comprising:
receiving, by a database on a server, at least one data set from one or more data repositories, the data set comprising one or more of legislative member attributes, legislative member votes, vote attributes, political action committee affiliations, political action and/or campaign committee contributions, and political action and/or campaign committee attributes, associated with at least one political entity, in at least one data format selected from the group consisting of XML, YAML, CSV and data extracted from an HTML page;
generating a scrubbed data set suitable for querying, by scrubbing at least one received data set to create a unique list of candidate committees associated with at least one current or former legislative member, wherein a data table that links current or former legislative members with candidate committees is cross-referenced against a manually maintained table to resolve incomplete and inconsistent data in the received data sets;
receiving, by the database, vote data comprising information about at least one voting event conducted by a legislative body, wherein the vote data is received by the database from one or more data repositories as a plurality of tables and is combined via a program running on the server into a single table within the database;
analyzing the scrubbed data set and/or vote data, by the server, based upon a query from a user comprising one or more parameters stored in the database; and
displaying the result of the query on a user interface.

2. The method of claim 1, further comprising:
storing the scrubbed data set in a non-transitory computer readable storage medium using an open-source relational database management system based on structured query language (SQL) by:
downloading, loading, aggregating, and analyzing the scrubbed data set periodically using BASH, PHP and R scripts executed by the server's processor;
aggregating the scrubbed data set; and
storing the aggregated data in aggregated tables configured to simplify and/or speed up processing of the stored data.

3. The method of claim 1, wherein analyzing the scrubbed data set comprises:
receiving or identifying a date range parameter comprising a datetime (t₀) and a datetime (tₙ), based on the user query;
dividing the date range into n sections (t₀, tₙ); and
generating a series of data sets at each point tₓ where 1≤x≤n.

4. The method of claim 1, wherein analyzing the scrubbed data set comprises:
analyzing the scrubbed data set in a chronological sequence, based on the user query; and determining one or more patterns as a function of time;
wherein the resulting patterns are displayed on the user interface as the result of the user query.

5. The method of claim 1, wherein the scrubbing of the received data set is performed by the execution of a program scheduled to execute daily on the server.

6. The method of claim 1, wherein analyzing the scrubbed data set comprises:
processing at least a subset of the data in the scrubbed data set using a divisive or agglomerative hierarchical clustering procedure to generate one or more clusters of data, wherein the one or more clusters of data are grouped using a predetermined dissimilarity criteria.

7. The method of claim 1, wherein the at least one political entity comprises:
a) a United States Congress;
b) a United States state legislature; or
c) a legislative body of a municipality.

8. The method of claim 1, wherein the data set received by the server further comprises at least one of biographic, political action committee affiliation, or bill sponsorship information associated with one or more members of the at least one political entity.

9. The method of claim 1, wherein the vote data received by the database comprises information regarding at least one bill, public or private law, resolution, or treaty voted on by one or more members of the at least one political entity.

10. The method of claim 1, wherein the data set received by the database comprises information about at least one political action committee and its contribution to a candidate committee of a current or former member of the at least one political entity.

11. The method of claim 1, wherein the open-source data table that links current or former members with candidate committees is a publicly-accessible resource hosted on a remote server.

12. The method of claim 1, further comprising:
defining, by the user, custom attribute data to be included in the at least one data set received from the one or more data repositories.

13. A system for generating a visualization of legislative events, comprising:
a database on a server; and
a processor configured to:
receive, by the database, at least one data set from one or more data repositories, the data set comprising one or more of legislative member attributes, legislative member votes, vote attributes, political action committee affiliations, political action and campaign committee contributions, and political action and campaign committee attributes, associated with at least one political entity, in at least one data format selected from the group consisting of XML, YAML, CSV and data extracted from an HTML page;
generate a scrubbed data set suitable for querying, by scrubbing at least one received data set to create a unique list of candidate committees associated with at least one current or former legislative member, wherein a data table that links current or former legislative members with candidate committees is cross-referenced against a manually maintained table to resolve incomplete and inconsistent data in the received data sets;
receive, by the database, vote data comprising information about at least one voting event conducted by a legislative body, wherein the vote data is received by the database from one or more data repositories as a plurality of tables and is combined via a program running on the server into a single table within the database;
analyze the scrubbed data set and/or vote data, by the server, based upon a query from a user comprising one or more parameters stored in the database; and
display the result of the query on a user interface.

14. The system of claim 13, wherein the processor is further configured to: store the scrubbed data set in a non-transitory computer readable storage medium using an open-source relational database management system based on structured query language (SQL) by:
downloading, loading, aggregating, and analyzing the scrubbed data set periodically using BASH, PHP and R scripts executed by the server's processor;
aggregating the scrubbed data set; and
storing the aggregated data in aggregated tables configured to simplify and/or speed up processing of the stored data.

15. The system of claim 13, wherein the processor is configured to analyze the scrubbed data set by:
receiving or identifying a date range parameter comprising a datetime (t₀) and a datetime (tₙ), based on the user query;
dividing the date range into n sections (t₀, tₙ); and
generating a series of data sets at each point tₓ where 1≤x≤n.

16. The system of claim 13, wherein the processor is configured to analyze the scrubbed data set by:
analyzing the scrubbed data set in a chronological sequence, based on the user query; and
determining one or more patterns as a function of time;
wherein the resulting patterns are displayed on the user interface as the result of the user query.

17. The system of claim 13, wherein the processor is configured to scrub the received data set by the execution of a program scheduled to execute daily on the server.

18. The system of claim 13, wherein the processor is configured to analyze the scrubbed data set by:
processing at least a subset of the data in the scrubbed data set using a divisive or agglomerative hierarchical clustering procedure to generate one or more clusters of data, wherein the one or more clusters of data are grouped using a predetermined dissimilarity criteria.

19. The system of claim 13, wherein the at least one political entity comprises:
a) a United States Congress;
b) a United States state legislature; or
c) a legislative body of a municipality.

20. The system of claim 13, wherein the data set received by the server further comprises at least one of biographic, political action committee affiliation, or bill sponsorship information associated with one or more members of the at least one political entity.

21. The system of claim 13, wherein the vote data received by the database comprises information regarding at least one bill, public or private law, resolution, or treaty voted on by one or more members of the at least one political entity.

22. The system of claim 13, wherein the data set received by the database comprises information about at least one political action committee and its contribution to a candidate committee of a current or former member of the at least one political entity.

23. The system of claim 13, wherein the open-source data table that links current or former members with candidate committees is a publicly accessible resource hosted on a remote server.

24. The system of claim 13, wherein the processor is further configured to:
define, by the user, custom attribute data to be included in the at least one data set received from the one or more data repositories.
